(19) United States
(12) Patent Application Publication
(10) Pub. No.: US 2026/0235874 A1
(43) Pub. Date: Aug. 13, 2026

(54) DISPLAY ADJUSTMENT FOR A HEAD-MOUNTABLE DISPLAY DEVICE

(71) Applicant: Apple Inc., Cupertino, CA (US)

(72) Inventors: Trevor S. Chambers, San Diego, CA (US); Alexander B. von Schulmann, Sunnyvale, CA (US); Matin Seadat Beheshti, Sunnyvale, CA (US)

(21) Appl. No.: 19/301,065

(22) Filed: Aug. 15, 2025

Related U.S. Application Data
(60) Provisional application No. 63/758,214, filed on Feb. 13, 2025.

(51) Int. Cl. G02B 27/01; G02B 7/12

(52) U.S. Cl. CPC G02B 27/0149; G02B 7/12; G02B 2027/0154

(57) ABSTRACT

A head-mountable display device (HMD) can include a frame, a display coupled to the frame, an adjustment mechanism, and a motion transfer member. The display can include a first optical module and a second optical module. The adjustment mechanism can be coupled to the first optical module. The motion transfer member can be coupled to the adjustment mechanism and the second optical module. The motion transfer member can extend between the first optical module and the second optical module. The adjustment mechanism can be configured to simultaneously adjust a position of the first optical module and a position of the second optical module relative to each other.

### CROSS REFERENCE TO RELATED APPLICATIONS

This application claims the benefit of U.S. Provisional Application No. 63/758,214, filed 13 February 2025, entitled “DISPLAY ADJUSTMENT FOR A HEAD-MOUNTABLE DISPLAY DEVICE,” the entire disclosure of which is hereby incorporated by reference.

### FIELD

The present disclosure relates generally to head-mountable display devices. More particularly, the present disclosure relates to adjusting an interpupillary distance of optical modules for a head-mountable display device.

### BACKGROUND

Recent advances in portable computing have led to an increase in the use of head-mounted display devices. Displays of the head-mountable display devices (HMDs) can include one or more optical modules that present images to the user’s eyes. Users of the head-mounted display devices can have unique interpupillary distances (IPD), or distances between the center of the user’s two pupils. For optimal use of the head-mountable display device, a position of the pair of optical modules can be adjusted so that the optical modules are aligned with the user’s interpupillary distance. However, systems for IPD adjustments within HMDs can be bulky, hard to manage or operate, and difficult to fit around other components of HMDs, especially when consumers prefer light-weight and small form factors.

### SUMMARY

In at least one example, a head-mountable display device can include a frame, and a display coupled to the frame. The display can include a first optical module and a second optical module. The head-mountable display device can also include an adjustment mechanism coupled to the first optical module and a motion transfer member coupled to both the adjustment mechanism and the second optical module. The motion transfer member can extend between the first optical module and the second optical module. The adjustment mechanism can be configured to simultaneously adjust a position of the first optical module and a position of the second optical module relative to each other.

In some examples, the adjustment mechanism can include a rack and pinion. The motion transfer member can include a cable. The rack and pinion can be disposed at an angle relative to the cable. The rack and pinion can include a rotating post, and a detent configured to engage with the rotating post. The rack and pinion can include a damping element configured to absorb energy from impacts. The adjustment mechanism can include a lead screw. The motion transfer member can include a flexible shaft. The head-mountable display device can include an impact absorption element disposed at the coupling between the motion transfer member and the second optical module.

In one aspect, an interpupillary distance adjustment mechanism can include a first guide coupled to a first optical module, a second guide coupled to a second optical module, an adjustment mechanism coupled to the first guide, and a motion transfer member. The motion transfer member can include a first longitudinal end coupled to the adjustment mechanism, a second longitudinal end coupled to the second guide, and an elongate portion extending from the first longitudinal end and the second longitudinal end. The adjustment mechanism can be configured to simultaneously adjust a position of the first guide and a position of the second guide relative to each other.

In some examples, the motion transfer member can extend through a midpoint of the interpupillary distance adjustment mechanism. The motion transfer member can extend through the midpoint in a non-linear configuration. The interpupillary distance adjustment mechanism can also include an actuator disposed off-center relative to a midpoint of the interpupillary distance adjustment mechanism. The actuator can be disposed adjacent to the first optical module. The actuator can include a first rack coupled to the first guide, a second rack coupled to the motion transfer member, and a circular gear engaging the first rack and the second rack.

In one aspect, a head-mountable display device can include a frame, and a display coupled to the frame. The display can include a first optical module and a second optical module. The head-mountable display device can also include an interpupillary distance adjustor configured to modify a distance between the first optical module and the second optical module. The interpupillary distance adjustor can include a first leadscrew coupled to the first optical module, a second leadscrew coupled to the second optical module and disposed at an angle relative to the first leadscrew, and a center joint connecting the first leadscrew and the second leadscrew. A rotation of the first leadscrew can cause an adjustment of the interpupillary distance between the first optical module and the second optical module.

In some examples, the adjustment of the first leadscrew can simultaneously adjust a position of the first optical module and the second optical module. The adjustment of the first leadscrew in a first rotational direction can be configured to translate the first optical module and the second optical module closer to one another. The adjustment of the first leadscrew in a second rotational direction can be configured to translate the first optical module and the second optical module farther from one another. The interpupillary distance adjustor can include an actuator disposed adjacent to the first lead screw.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a perspective view of one example of a head-mountable display device (HMD);

FIG. 2 illustrates a rear schematic view of one example of an HMD;

FIG. 3 illustrates a top schematic view of one example of an HMD;

FIG. 4 illustrates one example of an interpupillary distance (IPD) adjustment mechanism;

FIG. 7 illustrates a close-up of an actuator of an IPD adjustment mechanism;

FIG. 5 illustrates one example of an IPD adjustment mechanism in a non-linear configuration;

FIG. 6 illustrates one example of an IPD adjustment mechanism in a non-linear configuration;

FIG. 8 illustrates one example of an IPD adjustment mechanism including a motion transfer member in a non-linear configuration;

FIG. 9 illustrates one example of an IPD adjustment mechanism;

FIG. 10 illustrates one example of an IPD adjustment mechanism; and

FIG. 11 illustrates one example of an IPD adjustment mechanism in a non-linear configuration.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The present disclosure relates generally to head-mountable display devices. Examples of head-mountable devices can include optical devices, for example glasses lenses, goggles with lenses, transparent display windows, display screens or virtual/augmented reality devices that can include optical components. In these examples, the head-mountable device can be donned on the head of a user such that optically transparent widows, for example lenses and transparent optical displays, can be positioned in front of a user’s eyes. Displays of the head-mountable display devices (HMDs) can include one or more optical modules that present images to the user’s eyes. User’s heads can vary in size and shape, and more specifically the distance between a user’s eyes, otherwise known as interpupillary distance (IPD), can vary from user to user. For example, an average IPD for adults can be between 50–70 mm, with an average around 63 mm. The average IPD for children can be 43–58 mm. Display screens or display lenses provide the optimal immersive experience when the lenses are positioned directly in front of the user’s eyes.

Current wearable display devices can include an adjustment system that can adjust the position of the lenses or displays for a user. The current wearable display devices can adjust the displays, but the adjustment mechanisms do not allow for a symmetrical and precise adjustment of the displays of the wearable display device. However, the adjustment of the lenses to match a user’s IPD can be difficult as small adjustments to the lens of the wearable display devices can affect the immersive experience delivered to the user. Further, the addition of an IPD adjustment mechanism can add more components to the HMD. A persistent challenge when dealing with conventional IPD adjustment mechanism designs can lie in the placement and efficient packaging of an IPD adjustment mechanism within an HMD. For example, conventional HMDs can include a variety of components and structures (e.g., fans, processors, cameras, etc.) within the HMD, in addition to the IPD adjustment mechanism and any corresponding components (e.g., actuators). The numerous components can cause IPD adjustment mechanisms to be bulky, heavy, and positioned at or near the optical modules, to transfer motion or translate each optical module. Thus, the HMDs with an IPD adjustment mechanism can struggle to maintain a lightweight, slim form factor HMD. Further, conventional IPD adjustment mechanisms can be difficult to position and operate amongst the variety of controls and components within a conventional HMD.

The devices and systems described herein provide a lightweight, slim form factor HMD while providing an IPD adjustment mechanism. In addition, the optical modules can be moved independently and/or simultaneously to improve alignment with the IPD of the user. For example, an HMD can include a frame and a display. The display can include optical modules. The HMD can include an adjustment mechanism extending between the optical modules such that the adjustment mechanism can simultaneously adjust the positions of the optical modules. The IPD adjustment mechanism can appropriately position each optical module such that a user only needs to adjust one optical module to automatically, or simultaneously, adjust the other. Simultaneous adjustment prevents the user from having to independently adjust two optical modules. Independent adjustment can require more time and effort for adjustments and can lead to increased chances of adjustment. In some examples, the IPD adjustment mechanism can include an actuator, a motion transfer member, and guides that couple to the optical modules. In some examples, the IPD adjustment mechanism described herein can include a rack and pinion, a pair of lead screws, cables, rods, pulleys, and/or gears configured to move optical modules simultaneously and accurately.

A slim, lower profile, motion transfer member of the adjustment mechanism can extend, and transfer motion, from a first longitudinal end of the mechanism to a second longitudinal end. Therefore, the adjustment mechanism can be offset within the HMD. For example, the adjustment mechanism can be positioned off-center, such as at a longitudinal end of the HMD. Further, the lower profile motion transfer member can allow for a slimmer form factor for the HMD and expand the available space for other components of the HMD, particularly around the center or midpoint of the device.

To contour the shape of a user’s face, the optical modules can be offset from each other to match the contour. As such, the optical modules can be non-coplanar. The adjustment mechanism can adjust displays along non-parallel and/or non-colinear paths such that the HMD can be curved to conform to a human face can accommodate two displays being adjusted along the same curvature.

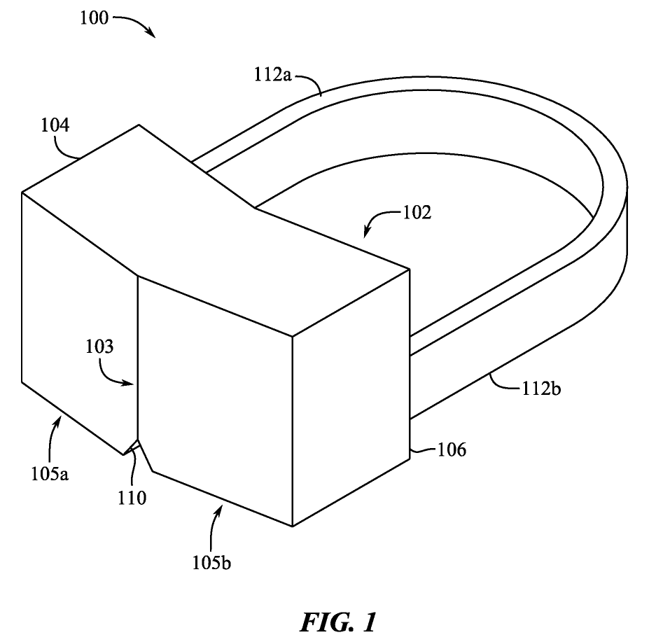

These and other examples are discussed below with reference to FIGS. 1–11. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a perspective view of one example of a head-mountable display device (HMD) 100 including a display portion 102, a frame 104, a facial interface 106, and one or more securement arms 112a, 112b coupled to the frame 104. The HMD 100 can be configured to be mounted to a head of a user. The HMD 100 can be configured to display media to the user. The HMD 100 can be configured to provide a comfortable user experience. In some example, components of the HMD can include a variety of polymers, ceramics, metals, or composite materials. The materials used to construct components of the HMD 100 can include silicone, foam, fabric, aluminum, steel, plastics, and/or other materials.

The display portion 102 can be positioned at least particularly in or on the frame 104. The display portion 102 can be configured to present augmented reality visualization, a virtual reality visualization, visual media, or another suitable visualization to the user. For example, visual media can include videos, live streams, websites, recordings, virtual reality settings, television, or other forms of visual media. The display portion 102 can include one or more optical lenses, optical modules, or display screens that are configured to be positioned in front of the eyes of a user. The optical modules of the display portion 102 can be a screen. The optical modules can be an organic light-emitting diode (OLED) screen, a light-emitting diode (LED) screen, a liquid crystal display (LCD) screen, or another type of screen. In some examples, the optical modules can include non-corrective lenses, transparent windows, or reflective materials. In some examples, light from the optical modules can travel through a lens before being perceived by a user. The optical modules can facilitate a desirable user experience by producing high-quality, engaging, and clear media for a user to perceive.

The frame 104 can be a housing of the display portion 102. The frame 104 can correspond to the contour of the user’s face. In some examples, the frame 104 can be angled. The frame 104 can include a first lateral side 105, a second lateral side 105b, and a central region 103. For example, as illustrated, a first lateral side 105a can be angled toward the central region 103. The second lateral side 105b can also be angled toward the central region 103. The first lateral side 105a and the second lateral side 105b can be on different planar, or non-coplanar. In some examples, the frame 104 can be curved from the first lateral side 105a to the second lateral side 105b. The central region 103 can similarly be curved. The frame 104 can have a constant radius. The frame 104 can have a curve defined by a complex curve that has a radius of curvature that varies through the curve.

The first and second lateral sides 105a, 105b can be symmetrical around the central region 103. The first and second lateral sides 105a, 105b can be mirrored from one another from the central region 103.

The central region 103 can define an angle between the first and second lateral sides 105a, 105b. The central region 103 can define a curvature of the frame 104. The central region 103 can be rounded. The central region 103 can define a continuously curved surface between the first and second lateral sides 105a, 105b.

The frame can include a nose piece 110. The nose piece 110 can be configured to conform to the shape of the nose of a user. The nose piece 110 can be configured to rest on the nose of the user. The nose piece 110 can be configured to support at least a portion of the weight of the HMD 100.

The nose piece 110 can be aligned with the central region 103. For example, the nose piece 110 and the central region 103 can be vertically aligned. The nose piece 110 can include a padded portion or a contoured portion. In some examples, at least nose piece 110 can be a combination of padded and contoured portions.

The facial interface 106 can be physically coupled to the frame 104. In some examples, the facial interface 106 can be integrated with the frame 104. The facial interface 106 can extend toward the user’s head and face from display portion 102 and/or frame 104. The facial interface 106 can provide an interface between the user’s head and the frame 104. For example, the facial interface 106 can be configured to maintain an appropriate and comfortable distance between the display portion 102 and the user’s face, for instance, the user’s eyes. The facial interface 106 can include portions configured to conform to, contact, or press against regions of the user’s face. The facial interface 106 can include portions configured to engage or shield the user’s face.

The one or more securement arms 112a, 112b can secure the HMD 100 relate to the user’s head. The one or more securement arms 112a, 112b can be connected to the display portion 102 or frame 104 and extend distally toward the rear of the user’s head. The one or more securement arms 112a, 112b can be configured to secure the display portion 102 or frame 104 in a position relative to the user’s head (e.g., such that the display portion 102 is maintained in front of the user’s eyes). The one or more securement arms 112a, 112b can be configured to support at least a portion of the weight of the HMD 100. The one or more securement arms 112a, 112b can extend over the user’s ears. In some examples, the one or more securement arms 112a, 112b can rest on the user’s ears to secure the HMD 100 via friction between the one or more securement arms 112a, 112b and the user’s head. In some examples, the one or more securement arms 112a, 112b can apply opposing pressures to the sides of the user’s head to secure the HMD 100 to the user’s head.

In some examples, the HMD 100 can also include various electrical and electronic components. For example, the HMD 100 can include one or more processors, speakers, batteries, screens, projectors, motors, linear actuators, cameras, sensors, wires, and other components. The various electrical and electronic components can be disposed within various parts of the HMD 100. For example, at least one of the securement arms 112a, 112b can include a battery and/or a speaker. The display portion 102 can include a processor, camera, and screen. The electronic components disposed in the securement arms 112a, 112b can be electrically coupled to the electronic components disposed within the display portion 102. The electrical and electronic components included in the HMD 100 can produce an immersive and desirable user experience.

Any of the features, components, and/or parts, including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

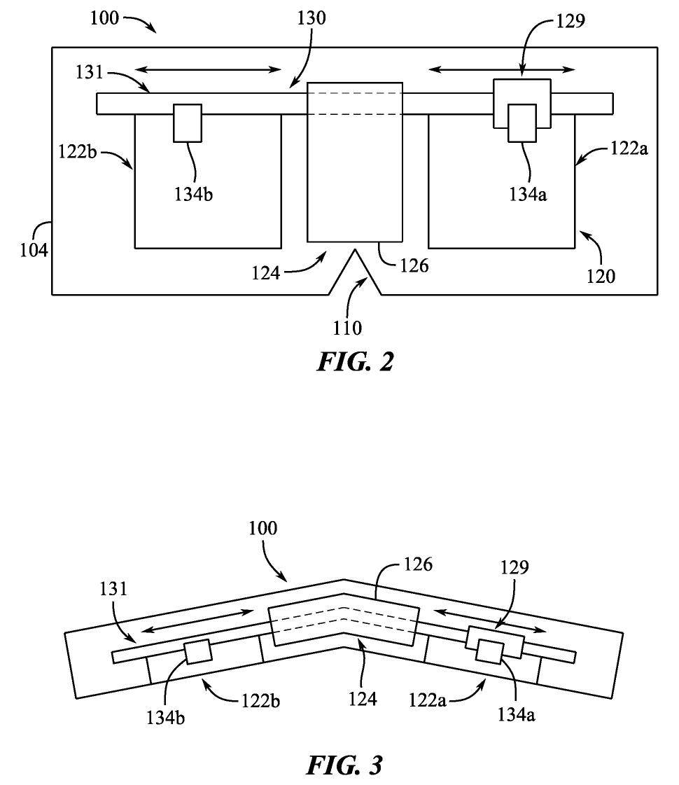

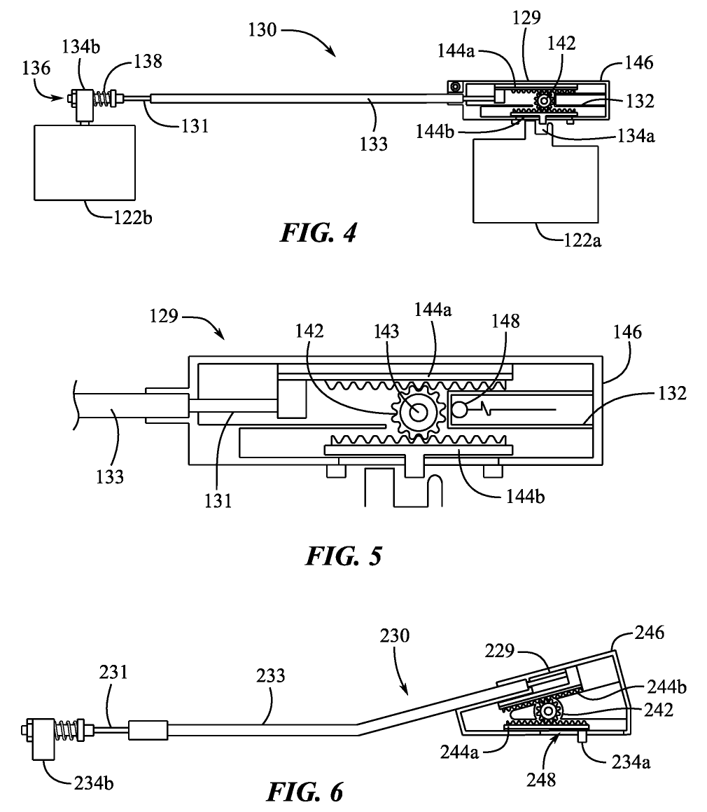

FIGS. 2 and 3 illustrate a rear and top schematic view of one example of the HMD 100 including the frame 104, a display 120 and an interpupillary distance (IPD) adjustment mechanism 130.

The display 120 can be disposed in the frame 104. The display 120 can be integrated into the frame 104. The display 120 can include one or more of optical modules 122a, 122b that are configured to present images to a user. For example, the display portion 120 can include a right optical module 122a and a left optical module 122b. The right optical module 122a can correspond to a right eye and the left optical module 122b can correspond to a left eye of the user. The right optical module 122a and left optical module 122b can be positioned to accommodate the nose piece 110. Right optical module 122a can define a first viewing plane. Left optical module 122b can define a second viewing plane. Right optical module 122a and left optical module 122b can be angled (e.g., a non-zero angle) with respect to each other to position the optical modules substantially parallel to the surface of the user’s face. In some examples, optical modules 122a, 122b can be non-parallel, offset, and/or not co-planar with respect to one another. The optical module 122a, 122b can each have a lens barrel with a display and a lens that present an image from the display to a corresponding eye of the user. In some examples, optical modules 122a, 122b can each be or can include a screen. In some examples, optical modules 122a, 122b can each be an OLED screen, an LED screen, an LCD screen, or another type of screen. In some examples, the optical modules 122a, 122b can each be or include a surface onto which an image is projected. In some examples, the optical modules 112a, 122b can each include transparent windows or lenses, corrective lenses, and so forth. In some examples, light from optical modules 122a, 122b can travel through a lens before being perceived by a user. The lens can be configured to change a characteristic of the light from optical modules 122a, 122b. For example, the lens can be configured to magnify or focus the media produced at optical modules 122a, 122b. In some examples, the lens can be configured to change some portions of the media produced at optical modules 122a, 122b. For example, the lens can change the proportions of the media produced at optical modules 122a, 122b. The lens and the optical modules 122a, 122b can facilitate a desirable user experience by producing high-quality, engaging, and clear media for a user to perceive. To accommodate users with different interpupillary distances, optical modules 122a, 122b of display 120 can be adjusted by the IPD adjustor or adjustment mechanism 130.

The IPD adjustment mechanism 130 can include an actuator 129, a motion transfer member 131, a right guide 134a and a left guide 134b. The IPD adjustment mechanism 130 can be configured to adjust the IPD distance between the optical modules 122a, 122b. In some examples, the IPD adjustment mechanism can be configured to simultaneously adjust the optical modules 122a, 122b to adjust the IPD distance between the optical modules 122a, 122b.

The actuator 129 can be positioned outside the internal central region 124. In some examples, the actuator 129 can be positioned proximal one of the right or left optical modules 122a, 122b. Accordingly, the actuator 129 can be positioned distal the other of the right or left optical modules 122a, 122b. The actuator 129 can be configured to cause motion within the IPD adjustment mechanism 130. The actuator 129 can be configured to cause motion of the motion transfer member 131. The actuator 129 can be configured to cause motion of the optical modules 122a, 122b. The actuator 129 can include a motor, a gear set, or other component configured to generate motion. For example, the actuator 129 can include a rack and pinion mechanism, a pair of lead screws, cables, rods, pulleys, and/or gears configured to generate motion.

The motion transfer member 131 can extend from the actuator 129. The motion transfer member 131 can extend between the optical modules 122a, 122b. The motion transfer member 131 can extend between the guides 134a, 134b. The motion transfer member 131 can extend from the actuator 129 to the left optical guide 134b. In some examples, the motion transfer member 131 can extend from the actuator 129 to the right optical guide 134a. The motion transfer member 131 can be configured to transfer motion from the actuator 129 to the guides 134a, 134b. The motion transfer member 131 can be configured to simultaneously transfer motion from the actuator 129 to the guides 134a, 134b.

The right guide 134a can couple the right optical module 122a to the IPD adjustment mechanism 130. In some examples, the right guide 134a can rigidly couple the right optical module 122a to the IPD adjustment mechanism 130. In some examples, the right guide 134a can couple the right optical module 122a to the actuator 129. In some examples, the right guide 134a can couple the right optical module 122a to the motion transfer member 131. The left guide 134b can couple the left optical module 122b to the IPD adjustment mechanism 130. In some examples, the left guide 134b can rigidly couple the left optical module 122b to the IPD adjustment mechanism 130. In some examples, the left guide 134b can couple the left optical module 122b to the motion transfer member 131. The guides 134a, 134b can be positioned outside the internal central region 124. The guides 134a, 134b can be positioned adjacent the optical modules 122a, 122b. The guides 134a, 134b can be angled (e.g., a non-zero angle) with respect to each other to position the optical modules 122a, 122b parallel to the surface of a user’s face. In some examples, the guides 134a, 134b can be non-parallel, offset, and/or non-coplanar with respect to one another. The guides 134a, 134b can be configured to cause movement of the optical modules 122a, 122b.

The frame 104 can include an internal central region 124. The internal central region 124 can be between the optical modules 122a, 122b. The internal central region 124 can be above the optical modules 122a, 122b. The motion transfer member 131 can pass through the internal central region 124. In some examples, no other components of the IPD adjustment mechanism 130 are positioned in the internal central region 124. For example, the actuator 129 can be located outside the internal central region 124. In some examples, components of the adjustment mechanism 130 in the internal central region 124 account for minimal space. The internal central region 124 can include an angle, curve, or other shape based on the configuration of the optical modules 122a, 122b. The frame 104 can include one or more components 126 of the HMD 100 in the internal central region 124.

The components 126 can include fans, motherboards, sensors, or other components of the HMD 100. The components 126 can be positioned in the internal central region 124 without interfering with the IPD adjustment mechanism 130. In some examples, the components 126 can be positioned above, below, in front of, or behind, the motion transfer member 131 in the internal central region 124. In some examples, such as when the internal central region 124 defines an angle, the components 126 can be positioned on either side of the angle or can be positioned in a linear space of the angle. In some examples, such as when the internal central region 124 defines a curve, the components can be positioned within the space defined by the curve, or the components 126 can define a similar curve.

Any of the features, components, and/or parts, including the arrangements and configurations thereof shown in FIGS. 2 and 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2 and 3.

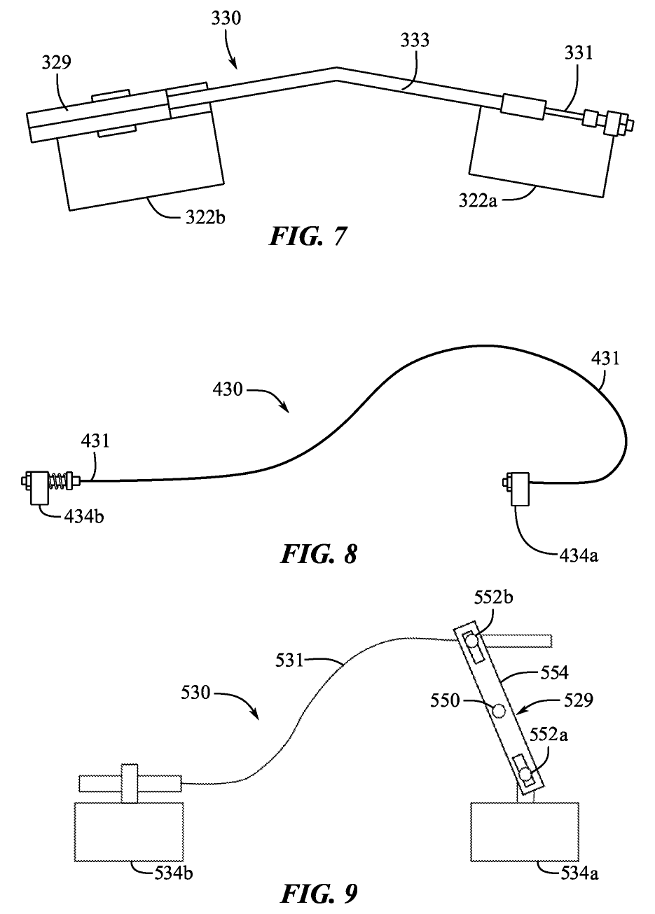

FIG. 4 illustrates one example of an IPD adjustment mechanism 130 coupled to optical modules 122a, 112b. FIG. 5 illustrates a close-up of the actuator 129 of the IPD adjustment mechanism 130. The optical modules 122a, 122b present images to the user. The optical modules 122a, 122b can be substantially similar to the optical modules 122a, 122b of FIGS. 2 and 3. The IPD adjustment mechanism 130 can include the actuator 129, the motion transfer member 131, the guides 134a, 134b, and a housing 146. The guides 134a, 134bcan be substantially similar to the guides 134a, 134b of FIGS. 2 and 3.

The actuator 129 can be configured to cause translation of the optical modules 122a, 122b. In one example, the guides 134a, 134bcan be coupled to and translate optical modules 122a, 122b towards or away from one another based on motion of the actuator 129. The actuator 129 can be a rack-and-pinion. The actuator 129 can include a circular gear 142 (e.g., the pinion) and a pair of linear gears 144a, 144b (e.g., the racks). In some examples, the actuator 129 can be positioned proximal one of the right or left optical modules 122a, 122b. Accordingly, the actuator 129 can be positioned distal the other of the right or left optical modules 122a, 122b. In some examples, the actuator 129 can be positioned above or below one of the right or left optical modules 122a, 122b.

The circular gear 142 can rotate about or around a center post 143 of the IPD adjustment mechanism 130 or actuator 129. In some examples, the circular gear 142 can be sized sufficiently such that linear gears 144a, 144b are free of engagement with each other during actuation. The first linear gear 144a can engage with an upper portion of circular gear 142 and the second linear gear 144b can engage with a lower portion of circular gear 142 (or vice versa). In other words, one of the linear gears 144a, 144b engages the circular gear 142 opposite the other.

The first linear gear 144a can be disposed on a first or top side of the IPD adjustment mechanism 130 or actuator 129. The second linear gear 144b can be disposed on a second, opposite, or bottom side of IPD adjustment mechanism 130 or actuator 129. The linear gears 144a, 144b can each be coupled to corresponding guides 134a, 134b. For example, the first linear gear 144a can be coupled to the right guide 134a and the second linear gear 144b can be coupled to the left guide 134b. In some examples, the first linear gear 144a, can be coupled directly to the right guide 134a, while the second linear gear 144b is coupled to left guide 134b via a motion transfer member 131. As the IPD adjustment mechanism 130 is actuated, the circular gear 142 can rotate and linear gears 144a, 144b can translate in alternate directions.

The housing 146 can enclose components of the IPD adjustment mechanism 130. The housing 146 can fully or partially enclose the actuator 129. The housing 146 can fully or partially enclose a portion of the motion transfer member 131. In some examples, the housing 146 can be positioned proximal one of the right or left optical modules 122a, 122b. Accordingly, the housing 146 can be positioned distal the other of the right or left optical modules 122a, 122b. In some examples, the housing 146 can be positioned above or below one of the right or left optical modules 122a, 122b. In some examples, a damping element, for example grease or other damping material, can be dispersed in or around the actuator 129 within the housing 146. The damping element(s) can be configured to dampen an impact event or energy from an impact event (e.g., from dropping the HMD 100). The damping element(s) can be configured to dampen an impact, or energy from an impact, that could otherwise be received by the optical modules 122a, 122b.

In some examples, a portion 132 of housing 146 can include a detent 148. The detent 148 can be configured to engage with the circular gear 142. In some examples, the detent 148 can be used to provide a tactile stop, or resistance, at certain intervals or locations when operating the IPD adjustment mechanism 130 (e.g., actuator 129) and translating the optical modules 122a, 122b.

The motion transfer member 131 can be configured to transfer motion from the actuator 129 to the guides 134a, 134b. Accordingly, the motion transfer member 131 can be configured to transfer motion from the actuator 129 to the optical modules 122a, 122b. The motion transfer member 131 can be configured to transfer longitudinal motion. The motion transfer member 131 can extend from the actuator 129. The motion transfer member 131 can extend between the optical modules 122a, 122b. The motion transfer member 131 can extend between the guides 134a, 134b. The motion transfer member 131 can extend from the actuator 129 to the left optical guide 134b. In some examples, the motion transfer member 131 can extend from the actuator 129 to the right optical guide 134a. In some examples, the motion transfer member 131 can be coupled to one of the linear gears 144a, 144b. In some examples, the motion transfer member 131 can be used to transfer motion of the second linear gear 144b to left guide 134b. The motion transfer member 131 can be configured to simultaneously transfer motion from the actuator 129 to at least one of the guides 134a, 134b. In some examples, the motion transfer member 131 can be used to transfer motion of the linear gear 144b to left guide 134b.

The motion transfer member 131 can be a longitudinally elongate member. The motion transfer member 131 can have a low profile. The motion transfer member 131 can be flexible. The motion transfer member 131 can be configured to bend or wind around intervening components of the HMD 100. For example, the motion transfer member 131 can bend or wind around components of the HMD 100 positioned between the optical modules 122a, 122b. In some examples, the motion transfer member 131 can include a cable. In some examples, the motion transfer member 131 can comprise a stainless steel (SUS) alloy, a titanium alloy, a composite, a polymer, or a combination thereof. The motion transfer member 131 can include a support tube 133.

The support tube 133 can receive the motion transfer member 131. The support tube 133 can surround at least a portion of the motion transfer member 131. The support tube 133 can extend between the guides 134a, 134b. The support tube 133 can define a pathway for the motion transfer member 131 around other components of the HMD 100. The support tube 133 can be flexible. The support tube 133 can be rigid. The support tube 133 can include flexible portions and rigid portions. The support tube 133 can be configured to protect the motion transfer member 131. In some examples, a damping element(s) can be dispersed in or around the support tube 133. The damping element(s) within the support tube 133 can help dampen and smoothen motion of the motion transfer member 131, which can pass through support tube 133. The damping element(s) can also dampen energy from an impact event (e.g., from dropping the HMD 100). The damping element(s) can dampen an impact that could otherwise be received by the optical modules 122a, 122b.

The IPD adjustment mechanism 130 can include an impact absorption element 136. The impact absorption element 136 can be disposed at the coupling between motion transfer member 131 and left guide 134b. The impact absorption element 136 can be configured to dampen the energy from an impact event (e.g., from dropping the HMD 100). The impact absorption element 136 can dampen an impact that would otherwise be received by optical modules 122a, 122b. For example, the impact absorption element 136 can include a spring 138. The spring 138 can further serve to bias the left guide 134b towards a left-most position (e.g., “left” relative to the viewing plane as illustrated by FIG. 4) and dampen movement via the IPD adjustment mechanism 130.

To actuate, function, or move the optical modules 122a, 122b, the circular gear 142 can be rotated, and the guides 134a, 134b can be translated towards one another, or away from one another. Such movement can adjust the IPD distance for the user by simultaneously adjusting the positions of the optical modules 122b, 122a toward or away from one another. The optical modules 122a, 122b can translate from a first position to a second position. The IPD adjustment mechanism 130 can be manually actuated by a user. For example, the user can rotate a dial to rotate the circular gear 142. In some examples, the IPD adjustment mechanism can be actuated by a motor. For example, a user can press a button to rotate the circular gear 142. In some examples, the user can grip the optical modules 122a, 122b and can translate them towards or away from one another. In some examples, movement of the optical modules 122a, 122b can be simultaneous, e.g., a user can move optical modules 122a, 122b an substantially similar distance either toward or away from one another.

The location of the actuator 129 and/or housing 146 and the motion transfer member 131 can circumvent or avoid spatial conflicts that would otherwise be present between the IPD adjustment mechanism 130 and additional components and mechanisms of the HMD 100. This can result in more efficient use of internal space and increased compactness of the HMD 100. For instance, spatial area circumvented by the offset position of the actuator 129 and/or housing 146 and the motion transfer member 131 extending between the optical modules 122a, 122b can provide room for additional hardware such as sensors, processors, or cooling mechanisms, without compromising a slim profile, form-factor, and/or functionality of the HMD 100.

Any of the features, components, and/or parts, including the arrangements and configurations thereof shown in FIGS. 4 and 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4 and 5.

FIGS. 6–11 illustrate examples of an IPD adjustment mechanism that can include features similar to the IPD adjustment mechanism 130 described above. Accordingly, like features are designated with like reference numerals, with the leading digits incremented to “2–6”. For example, the example depicted in FIGS. 6–11 include IPD adjustment mechanism 230, 330, etc., that may, in some respects, resemble IPD adjustment mechanism 130 of FIGS. 1–4.

Relevant disclosure set forth above regarding similarly identified features thus may not be repeated hereafter. Moreover, specific features of IPD adjustment mechanism 130 and related components shown in FIGS. 1–5 may not be shown or identified by a reference numeral in the drawings or specifically discussed in the written description that follows. However, such features may clearly be the same, or substantially the same, as features depicted in other examples and/or described with respect to such examples. Accordingly, the relevant descriptions of such features apply equally to the features of IPD adjustment mechanism 230, 330, etc., and related components depicted in FIGS. 6–11.

Any suitable combination of the features, and variations of the same, described with respect to IPD adjustment mechanism 130 and related components illustrated in FIGS. 1–5 can be employed with IPD adjustment mechanism 230, 330, etc., and related components of FIGS. 6-11, and vice versa. This pattern of disclosure applies equally to further examples depicted in subsequent figures and described hereafter, wherein the leading digits may be further incremented.

FIG. 6 illustrates one example of an IPD adjustment mechanism 230. The IPD adjustment mechanism 230 can include an actuator 229, a motion transfer member 231, a right guide 234a, a left guide 234b, and a housing 246. The guides 234a, 234b can be configured to couple to optical modules of an HMD.

The actuator 229 can be configured to cause translation of the guides 234a, 234b. In one example, the guides 234a, 234b can be coupled to and translate optical modules of an HMD. The actuator 229 can be a rack-and-pinion. The actuator 229 can include a circular gear 242 (e.g., the pinion) and a pair of linear gears 244a, 244b (e.g., the racks). In some examples, the actuator 229 can be positioned proximal one of the right or left guides 234a, 234b. Accordingly, the actuator 229 can be positioned distal the other of the right or guides 234a, 234b. In some examples, the actuator 229 can be positioned above or below one of the right or left guides 234a, 234b.

The circular gear 242 can rotate about or around a center post of the IPD adjustment mechanism 230 or actuator 229. In some examples, the circular gear 242 can be sized sufficiently such that linear gears 244a, 244b are free of engagement with each other during actuation. The first linear gear 244acan engage with an upper portion of circular gear 242 and the second linear gear 244b can engage with a lower portion of circular gear 242 (or vice versa). In other words, one of the linear gears 244a, 244b engages the circular gear 242 opposite the other.

The first linear gear 244a can be disposed on a first or top side of the IPD adjustment mechanism 230 or actuator 229. The second linear gear 244b can be disposed on a second, opposite, or bottom side of IPD adjustment mechanism 230 or actuator 229. The linear gears 244a, 244b can each be coupled to corresponding guides 234a, 234b. For example, the first linear gear 244a can be coupled to the right guide 234a and the second linear gear 244b can be coupled to the left guide 234b. In some examples, the first linear gear 244a can be coupled directly to the right guide 234a, while the second linear gear 244b is coupled to left guide 234b via the motion transfer member 231. In the illustrated examples, the second linear gear 244b can be positioned at an angle with respect to the first linear gear 244a.

The housing 146 can enclose components of the IPD adjustment mechanism 130. The housing 246 can fully or partially enclose the actuator 229. The housing 246 can fully or partially enclose a portion of the motion transfer member 231. In some examples, the housing 246 can be positioned proximal one of the right or left guides 234a, 234b. Accordingly, the housing 246 can be positioned distal the other of the right or left guides 234a, 234b. In some examples, the housing 246 can be positioned above or below one of the right or left optical modules. In some examples, a damping element, for example grease or other damping material, can be dispersed in or around the actuator 229 within the housing 246. The damping element(s) can be configured to dampen an impact event (e.g., from dropping an HMD). The damping element(s) can be configured to dampen an impact that could otherwise be received by optical modules. In some examples, the housing 146 can include an opening 248. The opening 248 can receive a portion of the right guide 234a (as illustrated), or the left guide 234b. In some examples, the opening 248 can enable one of the guides 234a, 234b to directly couple one of the linear gears 244a, 244b.

The motion transfer member 231 can be configured to transfer motion from the actuator 229 to the guides 234a, 234b. Accordingly, the motion transfer member 231 can be configured to transfer motion from the actuator 229 to at least one of the guides 234a, 234b. The motion transfer member 231 can be configured to transfer longitudinal motion. The motion transfer member 231 can extend from the actuator 229. The motion transfer member 231 can extend between the guides 234a, 234b (e.g., between optical modules of the HMD). The motion transfer member 231 can extend from the actuator 129 to the left optical guide 134b. In some examples, the motion transfer member 231 can extend from the actuator 229 to the right optical guide 234a. In some examples, the motion transfer member 231 can be coupled to one of the linear gears 244a, 244b. In some examples, the motion transfer member 231 can be used to transfer motion of the second linear gear 244b to left guide 234b. The motion transfer member 131 can be configured to simultaneously transfer motion from the actuator 229 to at least one of the guides 234a, 234b. The motion transfer member 231 can be a longitudinally elongate member. The motion transfer member 231 can have a low profile. The motion transfer member 231 can be flexible. As seen in the illustrated example, the motion transfer member 231 can be curved, or bent, such that an angle of a longitudinal axis of the housing 246 and/or actuator 229 of the IPD adjustment mechanism 230 is offset with respect to an angle of a longitudinal axis of the motion transfer member 231. The motion transfer member 231 can be configured to bend or wind around intervening components of the HMD. For example, the motion transfer member 231 can bend or wind around components of the HMD positioned between the guides 234a, 234b (e.g., between the optical modules). In some examples, the motion transfer member 231 can include a cable. In some examples, the motion transfer member 231 can comprise a stainless steel (SUS) alloy, a titanium alloy, a composite, a polymer, or a combination thereof.

The motion transfer member 231 can include a support tube 233. The support tube 233 can receive the motion transfer member 231. The support tube 233 can surround at least a portion of the motion transfer member 231. The support tube 233 can extend between the guides 234a, 234b. The support tube 233 can define a pathway for the motion transfer member 231 around other components of the HMD. In some examples, the support tube 233 can define a pathway with an angle, curve, or other non-linear configuration. The support tube 233 can be flexible. The support tube 233 can be rigid. The support tube 233 can include flexible portions and rigid portions. The support tube 233 can be configured to protect the motion transfer member 231. In some examples, a damping element(s) can be dispersed in or around the support tube 233. The damping element(s) within the support tube 233 can help dampen and smoothen motion of the motion transfer member 231, which can pass through support tube 233. The damping element(s) can also dampen an impact event (e.g., from dropping the HMD). The damping element(s) can dampen an impact that could otherwise be received by optical modules.

In some examples, the angle of the actuator 229 and/or the angle of the motion transfer member 231 enables movement of displays at an angle relative to one another. In some cases, this can be advantageous for a curved geometry of an HMD (e.g., see FIG. 1), to align with a natural curvature of the face and or pupils of a user. Accordingly, the IPD adjustment mechanism 230 can serve to enhance comfort, visual alignment, and the overall user experience. The location and/or angle of the actuator 229 and/or housing 146 and the motion transfer member 231 can circumvent or avoid spatial conflicts that would otherwise be present between the IPD adjustment mechanism 230 and additional components and mechanisms of the HMD. This can result in more efficient use of internal space and increased compactness of the HMD. For instance, spatial area circumvented by the offset position of the actuator 229 and/or housing 246 and the motion transfer member 231 extending between optical modules can provide room for additional hardware such as sensors, processors, or cooling mechanisms, without compromising a slim profile, form-factor, and/or functionality of the HMD.

Any of the features, components, and/or parts, including the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

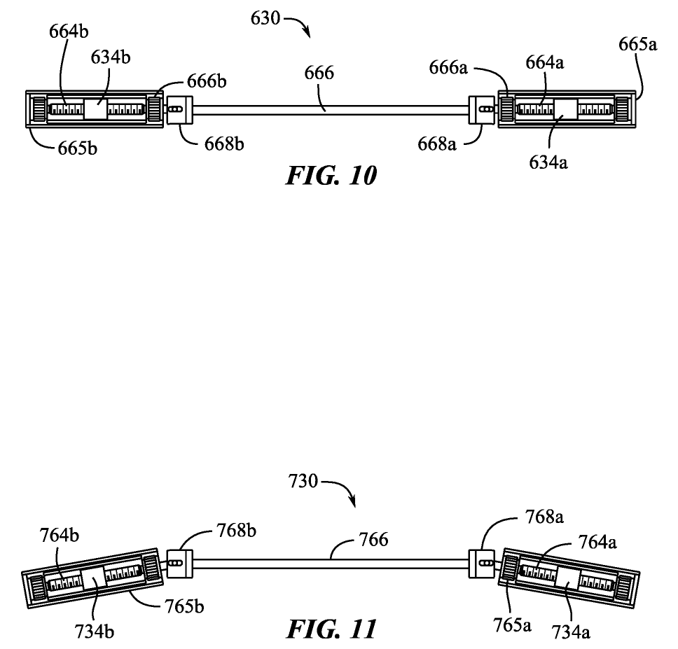

FIG. 7 illustrates one example of an IPD adjustment mechanism 330, a right optical module 322a, and a left optical module 322b. The IPD adjustment mechanism 330 can include an actuator 329, a motion transfer member 331, and a support tube 333. The IPD adjustment mechanism 330 can be substantially similar to the IPD adjustment mechanism 230. More specifically, the IPD adjustment mechanism 330 can be the IPD adjustment mechanism 230 in a mirrored configuration. The actuator 329, the motion transfer member 331, and the support tube 333 can be substantially similar to the actuator 229, the motion transfer member 231, and the support tube 233, respectively.

In the illustrated example, the actuator 329 can be positioned proximal the left optical module 322b. The actuator 329 can be positioned above the left optical module 322b. The motion transfer member 331 and the support tube 333 can extend from the actuator 329, proximal the left optical module 322b, to the right optical module 322a. The motion transfer member 331, and the support tube 333 can include an angle, curve, or other non-linear configuration as the motion transfer member 331 and the support tube 333 extend between the left optical module 322b and the right optical module 322a.

Like the IPD adjustment mechanism 230, the positioning of the actuator 329, motion transfer member 331, and the support tube 333 can be advantageous to an HMD. In some examples, the angle of the motion transfer member 331 enables movement of the optical modules 322a, 322b at an angle relative to one another. This can be advantageous for a curved geometry of an HMD (e.g., see FIG. 1), to align with a natural curvature of the face and or pupils of a user. Accordingly, the IPD adjustment mechanism 330 can serve to enhance comfort, visual alignment, and the overall user experience. The location and/or angle of the actuator 329 and the motion transfer member 331 can circumvent or avoid spatial conflicts that would otherwise be present between the IPD adjustment mechanism 330 and additional components and mechanisms of the HMD. This can allow for more efficient use of internal space and increase compactness of the HMD. For instance, spatial area circumvented by the offset position of the actuator 329 and the motion transfer member 331 extending between the optical modules 322a, 322b can provide room for additional hardware such as sensors, processors, or cooling mechanisms, without compromising a slim profile, form-factor, and/or functionality of the HMD. Further, the IPD adjustment mechanism 330 can provide an alternative configuration of components as compared to other IPD adjustment mechanisms described herein.

Any of the features, components, and/or parts, including the arrangements and configurations thereof shown in FIG. 7 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

FIG. 8 illustrates one example of an IPD adjustment mechanism 430. The IPD adjustment mechanism 430 can include a motion transfer member 431, a right guide 434a, and a left guide 434b.

The IDP adjustment mechanism 430 can be configured to cause translation of the guides 434a, 434b. The guides 434a, 434b can be substantially similar to one or more of guides 134a, 134b, 234a, and/or 234b. In one example, the guides 434a, 434b can be coupled to and translate optical modules of an HMD.

The motion transfer member 431 can be configured to transfer motion between the guides 434a, 434b. Accordingly, the motion transfer member 431 can be configured to transfer motion from one optical module to the other optical module. The motion transfer member 431 can be configured to transfer longitudinal motion. The motion transfer member 431 can extend between the right guide 434a and the left guide 434b.

The motion transfer member 431 can be a longitudinally elongate member. The motion transfer member 431 can have a low profile. The motion transfer member 431 can be flexible or pliable. The motion transfer member 431 can be disposed in a non-linear or curved configuration. The motion transfer member 431 can be configured to bend, curve, or wind around intervening components of an HMD. For example, the motion transfer member 431 can bend, curve, or wind around components of the HMD positioned between the guides 434a, 434b. The bend, curve, or wind of the motion transfer member 431 can relax spatial constraints and allow for more efficient and effective use of available space within the HMD. In some examples, the motion transfer member 431 can include a cable. In some examples, the motion transfer member 431 can comprise a stainless steel (SUS) alloy, a titanium alloy, a composite, a polymer, or a combination thereof. In some examples, the motion transfer member 431 can include retention clamps to assist with routing the motion transfer member 431. The retention clamps can be configured to maintain a position of the motion transfer member 431 while allowing the motion transfer member 431 to transfer motion. In some examples, the motion transfer member 431 includes a support tube surrounding the motion transfer member 431. In some examples, the support tube can be positioned using retention clamps. In some examples, the retention clamps or end fittings to couple the motion transfer member 431 to the right guide 434a and the left guide 434b.

Any of the features, components, and/or parts, including the arrangements and configurations thereof shown in FIG. 8 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 8.

FIG. 9 illustrates one example of an IPD adjustment mechanism 530. The IPD adjustment mechanism 530 can include an actuator 529 and a motion transfer member 531. The actuator 529 can include a body 554, a first pin/slot connection 552a, a second pin/slot connection 552b, and a pivot 550.

The body 554 can rotate about or around the pivot 550 of the IPD adjustment mechanism 530 or actuator 529. The first pin/slot connection 552a can be disposed on a first or bottom side of the IPD adjustment mechanism 530 or actuator 529. The second pin/slot connection 552b can be disposed on a second, opposite, or top side of IPD adjustment mechanism 530 or actuator 529. The first pin/slot connection 552a can be coupled to the right guide 534a of the optical module. The second pin/slot connection 552b can be coupled to the left guide 534b via the motion transfer member 531. The second pin/slot connection 552b can be coupled to an end of the motion transfer member 531, such that the end of the motion transfer member 531 can be linearly constrained within the second pin/slot connection 552b.

In operation, rotation of the body 554 can produce a lever effect or cause the second pin/slot connection 552b to pivot about the pivot 550. When the first pin/slot connection 552a translates and pivots about the pivot 550, the first pin/slot connection 552a can push, pull, or otherwise translate the opposite longitudinal end of the body 554, at the second pin/slot connection 552b, coupled to motion transfer member 531, and otherwise exert a pulling force on motion transfer member 531. For example, the first pin/slot connection 552a can pivot around pivot 550 and translate motion to the second pin/slot connection 552b. Such translation can provide a pulling or pushing motion to motion transfer member 531. In some examples, the horizontal motion of the right guide 534a can be in an opposite direction to the horizontal motion of the left guide 534b.

In some examples, the actuator 529 can include a housing. The housing can enclose components of the IPD adjustment mechanism 530. The housing can fully or partially enclose the actuator 529. In some examples, the housing can be configured such that the first pin/slot connection 552a and/or the second pin/slot connection 552b can extend out of the housing. The housing can be configured such that the body 554 can pivot about the pivot 550 within an interior and/or exterior of the housing. The housing can fully or partially enclose a portion of the motion transfer member 531. In some examples, the housing can be positioned proximal an edge of an HMD.

The motion transfer member 531 can be configured to transfer motion from the actuator 529. For example, the motion transfer member 531 can be configured to transfer motion from the second pin/slot connection 552b. The motion transfer member 531 can be configured to transfer longitudinal motion. The motion transfer member 531 can extend from the second pin/slot connection 552b. The motion transfer member 531 can be configured to simultaneously transfer motion from the actuator 529 to a different area of the HMD.

The motion transfer member 531 can be a longitudinally elongate member. The motion transfer member 531 can have a low profile. The motion transfer member 531 can be flexible. The motion transfer member 531 can be configured to bend or wind around intervening components of the HMD. For example, the motion transfer member 531 can bend or wind around components of the HMD. In some examples, the configuration of the actuator 529 and the motion transfer member 531 can be positioned to avoid intervening component of the HMD. In some examples, the motion transfer member 531 can include a cable. In some examples, the motion transfer member 531 can comprise a stainless steel (SUS) alloy, a titanium alloy, a composite, a polymer, or a combination thereof. The motion transfer member 531 can include a support tube.

The location of the actuator 529 and the motion transfer member 531 can circumvent or avoid spatial conflicts that would otherwise be present between the IPD adjustment mechanism 530 and additional components and mechanisms of the HMD. This can allow for more efficient use of internal space and increase compactness of the HMD. For instance, spatial area circumvented by the offset position of the actuator 529 and the motion transfer member 531 extending between through the HMD can provide room for additional hardware such as sensors, processors, or cooling mechanisms, without compromising a slim profile, form-factor, and/or functionality of the HMD.

Any of the features, components, and/or parts, including the arrangements and configurations thereof shown in FIG. 9 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 9.

FIG. 10 illustrates one example of an IPD adjustment mechanism 630. The IPD adjustment mechanism 630 can include a right lead screw 664a, a left lead screw 664b, a shaft 666, a right guide 634a, and a left guide 634b. The guides 634a, 634b can be configured to couple to optical modules.

The right lead screw 664a can be disposed on a first lateral side of the IPD adjustment mechanism 630. The left lead screw 664b can be disposed on a second lateral side of the IPD adjustment mechanism 630. The right lead screw 664a can be coupled to the shaft 666 via coupling member 668a. The left lead screw 664b can be coupled to the shaft 666 via coupling member 668b. The lead screws 634a, 634b can be rotationally fixed to the shaft 666. For example, the lead screws 634a, 634b and the shaft 666 can be rotated as one body or member. The lead screws 634a, 634b can be a back-drivable, multi-start leadscrews. In some examples, lead screws 664a, 664acan be co-planar and in parallel and/or offset from each other. In at least one example, each of lead screws 664a, 664b can be coupled to a corresponding guide of guides 634a, 634a. For example, the right lead screw 664acan be coupled to the right guide 634a and the left lead screw 664b can be coupled to the left guide 634b. In some examples, lead screws 664a, 664b can be oppositely threaded, such that rotation of flexible shaft 666 and lead screws 664a, 664b can simultaneously translate guides 634a, 634b away from or towards one another.

The right lead screw 664a can be partially or fully enclosed in a right lead screw housing 665a. The left lead screw 664b can be partially or fully enclosed in a left lead screw housing 665b. The lead screw housings 665a, 665b can include a right bearing 666a and a left bearing 666b, respectively. In some examples, the bearings 666a, 666b can be ball bearings. The bearings 666a, 666b can be disposed at a longitudinal end of lead screw housings 665a, 665b. The bearings 666a, 666b can be rotated and can allow for simultaneous rotation of the lead screws 664a, 664b.

The shaft 666 can extend between the lead screws 664a, 664b. The shaft 666 can be configured to transfer rotation motion between the lead screws 664a, 664b. The shaft 666 can be configured to couple the lead screws 664a, 664b together. The shaft 666 can be flexible. The shaft 666 can be formed from a pliable material. The shaft 666 can be configured to be curved while still maintaining a torsional rigidity—or effectively transfer rotation motion.

The IPD adjustment mechanism 630 can be manually actuated by a user. In some examples, the user can rotate a dial to manually rotate lead screws 664a, 664b relative to the bearings 666a, 666b. The IPD adjustment mechanism 630 can be actuated by a motor. In some examples, a user can press a button to rotate one or both of lead screws 664a, 664b relative to bearings 666a, 666b. When actuated, the lead screws 664a, 664b and the shaft 666 can be rotated relative to bearings 666a, 666b. When the lead screws 664a, 664b and the shaft 666 are rotated relative to bearings 666a, 666b the guides 634a, 634b can either move toward or move away from one another to adjust the IPD distance for the user. In some examples, the user can grip optical modules attached to guides 634a, 634b and move the optical modules towards or away from one another. In some examples, movement of guides 634a, 634b and their corresponding optical modules is simultaneous, such that a user can also move only one of the optical modules or guide rods and the other optical module or guide rod moves an equal amount either toward or away from one another.

The location of the lead screws 664a, 664b proximal the guides 634a, 634b and the shaft 666 extending between the lead screws 664a, 664b can circumvent or avoid spatial conflicts that would otherwise be present between the IPD adjustment mechanism 630 and additional components and mechanisms of the HMD. This can allow for more efficient use of internal space as well as increasing compactness of the HMD. For instance, spatial area circumvented by the offset position of the lead screws 664a, 664b and the shaft 666 extending between through the HMD can provide room for additional hardware such as sensors, processors, or cooling mechanisms, without compromising a slim profile, form-factor, and/or functionality of the HMD.

Any of the features, components, and/or parts, including the arrangements and configurations thereof shown in FIG. 10 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 10.

FIG. 11 illustrates one example of an IPD adjustment mechanism 730. The IPD adjustment mechanism 730 can include a right lead screw 764a, a left lead screw 764b, a shaft 766, a right guide 734a, and a left guide 734b. The guides 734a, 734b can be configured to couple to optical modules.

The right lead screw 764a can be disposed on a first lateral side of the IPD adjustment mechanism 730. The left lead screw 764b can be disposed on a second lateral side of the IPD adjustment mechanism 730. The right lead screw 764acan be coupled to the shaft 766 via coupling member 768a. The left lead screw 764b can be coupled to the shaft 766 via coupling member 768b. The lead screws 764a, 764b can be rotationally fixed to the shaft 766. For example, the lead screws 764a, 764band the shaft 766 can be rotated as one body or member. The lead screws 764a, 764b can be a back-drivable, multi-start leadscrews. In some examples, lead screws 764a, 764acan be arranged in a non-linear or non-planar configuration with respect to one another. For example, the lead screws 764a,764b can be offset from the shaft 766. In some examples, the lead screws 764a,764b can be offset from the shaft 766 by at least about 5-degrees or more. The coupling members 768a, 768b can be configured to allow the transfer of the rotation motion, even when the lead screws 764a, 764b are positioned at an angle. In some examples, each of lead screws 764a, 764b can be coupled to a corresponding guide of guides 734a, 734a. For example, the right lead screw 764a can be coupled to the right guide 734a and the left lead screw 764b can be coupled to the left guide 734b. The lead screws 764a, 764b can be linearly coupled to the guides 734a, 734b. Accordingly, if the lead screws 764a, 764b are positioned at an angle, the guides 734a, 734b can be positioned at a similar angle. The offset or angle of the lead screws 764a, 764b and/or the guides 734a, 734b can be selected to accommodate the general curvature of an HMD and/or a face of a user. In some examples, lead screws 764a, 764bcan be oppositely threaded, such that rotation of flexible shaft 766 and lead screws 764a, 64b can simultaneously translate guides 734a, 734b away from or towards one another.

The right lead screw 764a can be partially or fully enclosed in a right lead screw housing 765a. The left lead screw 764b can be partially or fully enclosed in a left lead screw housing 765b. The housings 765a, 765b can be positioned at an angle substantially similar to the angle of the lead screws 764a, 764b. The lead screw housings 765a,765b can include a right bearing 66a and a left bearing 6676b, respectively. In some examples, the bearings 766a, 766b can be ball bearings. The bearings 766a, 766b can be disposed at a longitudinal end of lead screw housings 765a, 765b. The bearings 766a, 766b can be rotated and can allow for simultaneous rotation of the lead screws 764a, 764b.

The shaft 766 can extend between the lead screws 764a, 764b. The shaft 766 can be configured to transfer rotation motion between the lead screws 764a, 764b. The shaft 766 can be configured to couple the lead screws 764a, 764b together. The shaft 766 can be flexible. The shaft 766 can be formed from a pliable material. The shaft 766 can be configured to be curved while still maintaining a torsional rigidity—or effectively transfer rotation motion.

The IPD adjustment mechanism 730 can be manually actuated by a user. In some examples, the user can rotate a dial to manually rotate lead screws 764a, 764b relative to the bearings 766a, 766b. The IPD adjustment mechanism 730 can be actuated by a motor. In some examples, a user can press a button to rotate one or both of lead screws 764a, 764b relative to bearings 766a, 766b. When actuated, the lead screws 764a, 764b and the shaft 766 can be rotated relative to bearings 766a, 766b. When the lead screws 764a, 764b and the shaft 766 are rotated relative to bearings 766a, 766b the guides 734a, 734b can either move toward or move away from one another to adjust the IPD distance for the user. In some examples, the user can grip optical modules attached to guides 734a, 734b and move the optical modules towards or away from one another. In some examples, movement of guides 734a, 734b and their corresponding optical modules is simultaneous, such that a user can also move only one of the optical modules or guide rods and the other optical module or guide rod moves an equal amount either toward or away from one another.

The location of the lead screws 64a, 6674b proximal the guides 734a, 734b and the shaft 766 extending between the lead screws 764a, 764b can circumvent or avoid spatial conflicts that would otherwise be present between the IPD adjustment mechanism 730 and additional components and mechanisms of the HMD. This can allow for more efficient use of internal space and increase compactness of the HMD. For instance, spatial area circumvented by the linearly offset position of the lead screws 764a, 764b and the shaft 766 extending between through the HMD can provide room for additional hardware such as sensors, processors, or cooling mechanisms, without compromising a slim profile, form-factor, and/or functionality of the HMD.

Any of the features, components, and/or parts, including the arrangements and configurations thereof shown in FIG. 11 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 11.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID’s, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user’s general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. A head-mountable display device, comprising:
a frame;
a display coupled to the frame and comprising a first optical module and a second optical module;
an adjustment mechanism coupled to the first optical module; and
a motion transfer member coupled to the adjustment mechanism and the second optical module, the motion transfer member extending between the first optical module and the second optical module;
wherein the adjustment mechanism is configured to simultaneously adjust a position of the first optical module and a position of the second optical module relative to each other.

2. The head-mountable display device of claim 1, wherein the adjustment mechanism comprises a rack and pinion.

3. The head-mountable display device of claim 2, wherein the motion transfer member comprises a cable.

4. The head-mountable display device of claim 3, wherein the rack and pinion is disposed at an angle relative to the cable.

5. The head-mountable display device of claim 3, wherein the rack and pinion comprises a rotating post and a detent configured to engage the rotating post.

6. The head-mountable display device of claim 3, wherein the rack and pinion comprises a damping element configured to absorb energy.

7. The head-mountable display device of claim 1, wherein the adjustment mechanism comprises a lead screw.

8. The head-mountable display device of claim 1, wherein the motion transfer member comprises a flexible shaft.

9. The head-mountable display device of claim 1, further comprising an impact absorption element disposed between the motion transfer member and the second optical module.

10. An interpupillary distance adjustment mechanism, comprising:
a first guide coupled to a first optical module;
a second guide coupled to a second optical module;
an adjustment mechanism coupled to the first guide; and
a motion transfer member comprising:
a first longitudinal end coupled to the adjustment mechanism;
a second longitudinal end coupled to the second guide; and
an elongate portion extending from the first longitudinal end and the second longitudinal end;
wherein the adjustment mechanism is configured to adjust a first position of the first guide relative to a second position of the second guide.

11. The interpupillary distance adjustment mechanism of claim 10, wherein the motion transfer member extends through a midpoint of the interpupillary distance adjustment mechanism.

12. The interpupillary distance adjustment mechanism of claim 11, wherein the motion transfer member extends through the midpoint in a non-linear configuration.

13. The interpupillary distance adjustment mechanism of claim 10, further comprising an actuator disposed off-center relative to a midpoint of the interpupillary distance adjustment mechanism.

14. The interpupillary distance adjustment mechanism of claim 13, wherein the actuator is disposed adjacent to the first optical module.

15. The interpupillary distance adjustment mechanism of claim 13, wherein the actuator comprises:
a first rack coupled to the first guide;
a second rack coupled to the motion transfer member; and
a circular gear engaging the first rack and the second rack.

16. A head-mountable display device, comprising:
a frame;
a display coupled to the frame, the display comprising a first optical module and a second optical module; and
an interpupillary distance adjustor configured to modify a distance between the first optical module and the second optical module, the interpupillary distance adjustment mechanism comprising:
a first leadscrew coupled to the first optical module;
a second leadscrew coupled to the second optical module and disposed at an angle relative to the first leadscrew; and
a center joint connecting the first leadscrew and the second leadscrew;
wherein a rotation of the first leadscrew causes an adjustment of a distance between the first optical module and the second optical module.

17. The head-mountable display device of claim 16, wherein the adjustment of the first leadscrew simultaneously adjusts a position of the first optical module and the second optical module.

18. The head-mountable display device of claim 16, wherein the adjustment of the first leadscrew in a first rotational direction is configured to translate the first optical module closer relative to the second optical module.

19. The head-mountable display device of claim 18, wherein the adjustment of the first leadscrew in a second rotational direction is configured to translate the first optical module further relative to the second optical module.

20. The head-mountable display device of claim 16, wherein the interpupillary distance adjustor further comprises an actuator disposed adjacent to the first leadscrew.
